(19) United States
(12) Patent Application Publication
(10) Pub. No.: US 2003/0229795 A1
(43) Pub. Date: Dec. 11, 2003

(54) Secure assembly of security keyboards

(75) Inventors: Eckhard Kunigkeit, Stuttgart (DE); Thomas Walz, Niefern (DE)

Correspondence Address: William A. Kinnaman, Jr., IBM Corporation, IP Law Department, 2455 South Road - M/S 386, Poughkeepsie, NY, 12601, US

(73) Assignee: INTERNATIONAL BUSINESS MACHINES CORPORATION, Armonk, NY

(21) Appl. No.: 10/368,227

(22) Filed: Feb. 18, 2003

(30) Foreign Application Priority Data
Feb. 19, 2002 (DE) 02003688.5

(51) Int. Cl. H04L 9/00

(52) U.S. Cl. 713/189

(57) ABSTRACT

The present invention contemplates a secure and auditable assembly process for security keyboards which comprises a first country-independent assembly process at the security keyboard manufacturer (SKM) side resulting in country-independent assembled parts, a second and final country-specific assembly process at the ATM manufacturer side resulting in a final assembly of the country-independent parts with their appropriate country-specific layout parts to a complete security keyboard, and a final authentication process at the ATM manufacturer side for activation of the security functions of the assembled security keyboard by the authorized ATM manufacturer.

### BACKGROUND OF THE INVENTION

1. Field of the Invention

The present invention relates to a method for secure assembly of security keyboards outside the secure environment of the security keyboard manufacturer (SKM).

2. Description of the Related Art

At the present time a range of equipment is employed in automatic teller machines (ATMs) for data entry or output. The devices have a communication interface in such a way that the control unit of the ATM can send commands to the devices, which are executed by the devices.

After execution of the command the device sends a reply with the required data to the control unit of the ATM. Certain security provisions are associated with this equipment in order to be able to avoid any possible undesired manipulation. The security of confidential information and the protection of data input and output from possible influences or manipulation is generally effected by means of electronic or mechanical security measures, such as, for example, the physical incorporation of various security-relevant components into one security module. Especially security-sensitive components or modules include, in particular, data input keyboards, key memory for storing confidential keys, e.g. for coding data transfer, and security circuits for electronic protection of security-relevant components. Thus, keyboards in particular have to be protected against simultaneous disclosure of input data, such as a personal identification number (PIN).

A security module for an electronic funds transfer system is known from European Patent Application EP A-0186981. The security module is located in an impact-resistant housing. The module has a PIN entry block and can key confidential data, such as, for example, the PIN, and thus offers access to this data to other equipment. An extensive study of the physical security of systems for an electronic funds transfer is known from the IBM document “Physical Security for the IBM Transaction Security System”, IBM Charlotte, N.C., 28257, May 6, 1991, by G. P. Double. This document proposes various test methods and possible protective measures. In particular, this document teaches the use of a so-called intrusion detection screen for the electronic detection of mechanical penetration of the film. The intrusion detection screen comprises a flexible circuit board with thin meandering conductor paths or a combination of flexible circuit board with thin meandering conductor paths and a printed circuit board with integrated thin meandering conductor paths. If the conductor paths are short-circuited or destroyed by mechanical action, such as, for example, penetration or tearing, this is recognized by one of the built-in security switches. A monitoring logic connected to the intrusion detection screen recognizes changes in the resistance network of the protective film and sets off a suitable alarm which can lead, for example, to the deletion of security-relevant data.

To make manipulations at security keyboards, which are intended, for example, for use in ATMs or electronic funds transfer, more difficult, a range of measures is known which enhance data security. A known method for this is to encapsulate the electronics to be protected including the keyboard. Apart from the encapsulation method, it is also usual to embed the security logic with data memory and the keyboard required for data input in a housing and to wrap the housing in a security film. The security film is here designed in such a way that removal of or damage to the security film leads to a corresponding alarm.

Apart from the data memory, which contains any security-relevant data, the keyboard must be protected so as to prevent or make more difficult the unauthorized ‘theft’ of the inputted information, such as, for example, a personal identification number (PIN).

FIG. 1 shows an arrangement for the protection from unauthorized ‘theft’ of the inputted information, such as, for example, a PIN in accordance with the state of the art. That security keyboard consists of a secure module that is country-independent and a country-specific layout part. The secure module includes a printed circuit board (PCB) 1 having a security module 2 containing all security-relevant functions encapsulated with a security film that is connected to a built-in security switch (not shown), metal domes 5 for key elements 3, a metal dome 7 for a security mechanism 6 to assure integrity against manipulation for the PIN entry block, a spacer layer 8, and a gasket 9. The country-specific layout parts include keys 4, a spacer layer 10, a cover 11, and mounting screws 12. When the key 4 is pressed, the metal dome 5 snaps in and short-circuits the electrical contacts 3 for the key, which is recognized by the built-in security switch as a valid key stroke. Furthermore, the PCB 1 has one or more security electrical contacts 6 with an assigned metal dome 7. The security electrical contact 6 is connected to a built-in security switch. When the security keyboard is assembled and mounted by the security keyboard manufacturer (SKM) using screws and nuts 12, the cover 11, spacer 10, and gasket 9 force metal dome 7 to snap in and to short-circuit security contacts 6. This indicates to the built-in security switch that the keyboard is assembled correctly. Otherwise, the security switch erases all security-relevant data. Attempts to manipulate the keyboard, for example recording of inputted data, e.g. PINs, require mechanical access to the keys 4 and their contacts 3. This requires disassembling of the keyboard which opens the electrical contact 6. This activates the built-in security switch the electrical contact 6 is connected to and erases all security-relevant data.

Most ATM manufacturers sell their ATM machines worldwide. This means that for each security keyboard a country-specific layout part is required.

Presently the SKM must supply security keyboards to the ATMs in a completely assembled state including the pre-installed country-specific layout part and security feature for data integrity being enabled. That means that the ATM manufacturer needs additional storage room for the most demanded security keyboards to promptly service defective security keyboards all over the world. A final assembly of the security keyboard with the appropriate country-specific layout parts in the ATM environment is practically desirable and cost reducing, however presently there exists no secure method allowing the final assembly of the security keyboards outside the SKM's secure environment due to the lack of a secure process for avoiding manipulation on the security keyboard.

### SUMMARY OF THE INVENTION

It is therefore an object of the present invention to overcome the aforementioned disadvantages of the prior art and provide a method for a secure final assembly of the security keyboard outside of the SKM environment without allowing manipulation.

The present invention contemplates a secure and auditable assembly process for security keyboards which comprises a first country-independent assembly process at the SKM side resulting in country-independent assembled parts, a second and final country-specific assembly process at the ATM manufacturer side resulting in a final assembly of the country-independent parts with their appropriate country-specific layout parts to a complete security keyboard, and a final authentication process at the ATM manufacturer side for activation of the security functions of the assembled security keyboard by the authorized ATM manufacturer.

### DESCRIPTION OF THE DRAWINGS

The novel features believed characteristic of the invention are set forth in the appended claims. The invention itself, however, as well as a preferred mode of use, further objects and advantages thereof, is best understood by reference to the following detailed description of an illustrative detailed embodiment and when read in conjunction with the accompanying drawings, wherein:

FIG. 1 shows a completely assembled security keyboard which has been assembled according to the present invention;

FIG. 2 shows a country-independent assembled part of the security keyboard which has been assembled by the SKM;

FIG. 3 shows the overall method for secure assembly of the security keyboard according to the present invention; and

FIG. 4 shows in more detail the components and data stored in the security module of the country-independent part as provided by the provider to the assembler.

While the invention is described in connection with a preferred embodiment, the description is not intended to limit the invention to that embodiment. On the contrary, the invention is intended to cover all alternatives, modifications and equivalents as may be included within the spirit and scope of the invention as described by the appended claims.

### DETAILED DESCRIPTION OF THE INVENTION

The secure and auditable assembly process for a security keyboard may be divided into two main process parts. The first process part is exclusively controlled and performed by the SKM (provider). It concerns in principle the assembly of the country-independent part. It is called the country-independent assembly process. Referring to the security keyboard shown in FIG. 2, the country-independent part includes following components: a printed circuit board (PCB) 1 with electrical contacts 3 for the key elements and electrical elements 6 for the security mechanism to assure integrity against manipulation for the PIN entry block, a security module 2, metal domes 5 for the key elements, a metal dome 7 for the security mechanism to assure integrity against manipulation for the PIN entry block, a spacer layer 8, and a gasket 9.

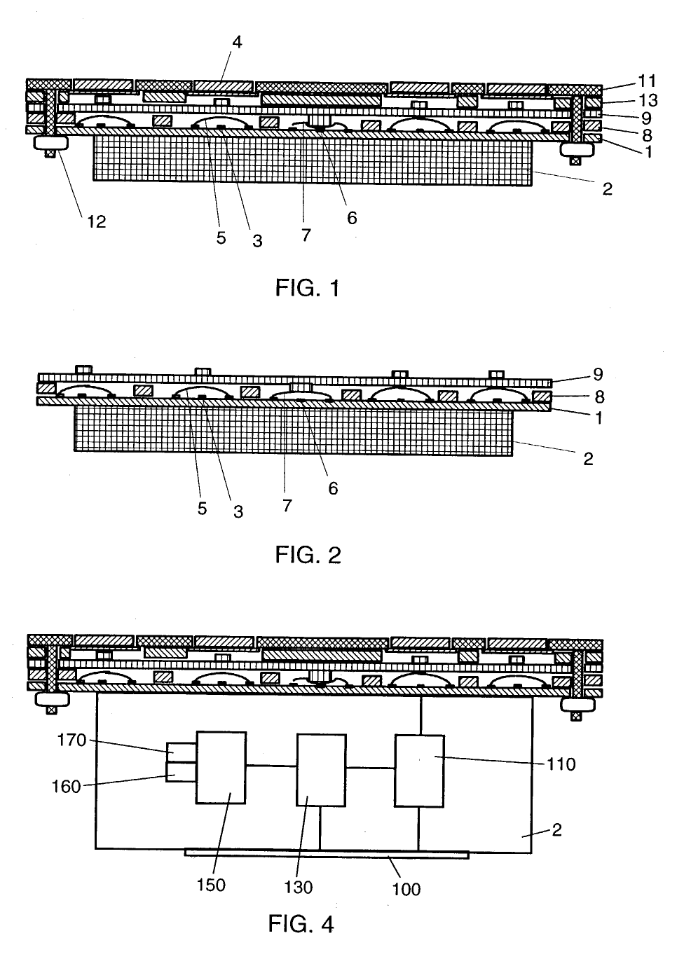

The second process part is performed by the ATM manufacturer (assembler). It concerns in principal the assembly of the country-independent part with its assigned country-specific layout parts. It is called the country-specific assembly process. Referring to the security keyboard shown in FIG. 1, the country-specific layout part includes following components: keys 4, a spacer layer 13, a cover 11 and mounting screws 12. Different key sets are provided according to the required country languages.

The SKM provides the assembled, country-independent parts and the non-assembled country-specific layout parts to the ATM manufacturer, and the ATM manufacturer assembles the country-independent parts with the appropriate country-specific layout parts to complete security keyboards in its own environment.

Finally, the ATM manufacturer performs an authentication process with the security keyboard. If the authentication is successful the user-authentication of the security keyboard as well as the security function protecting the security keyboard against mechanical manipulation are automatically activated, or the ATM manufacturer may be entitled to activate the user-authentication as well as the security function of the security keyboard by further commands. The authentication may be performed by means of an asymmetric or symmetric authentication process.

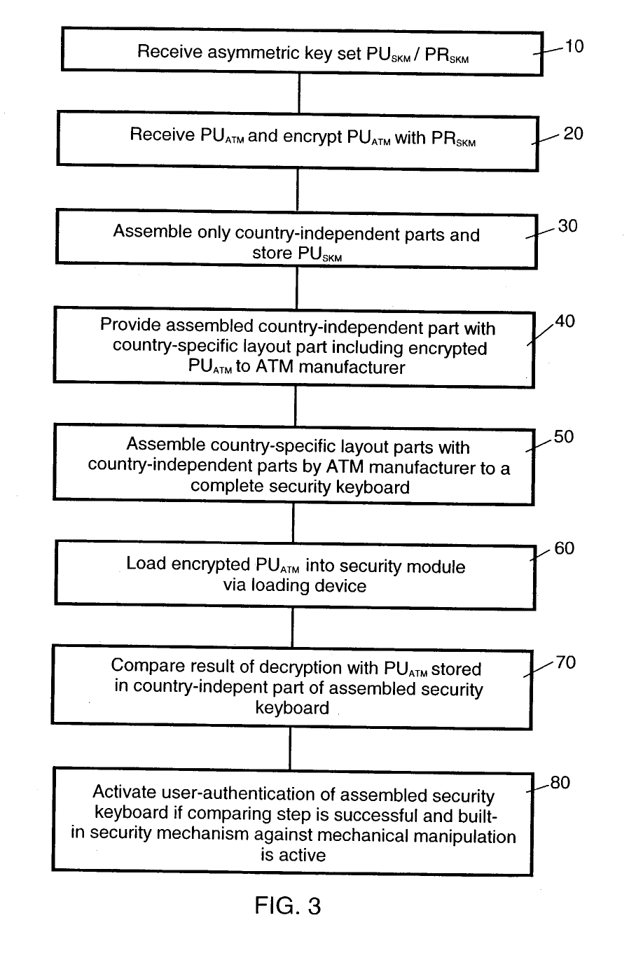

FIG. 3 shows in more detail the inventive method to assemble the security keyboard partly at the SKM side and finally at the ATM manufacturer side in conjunction with the authentication process allowing activation of the security function of the security keyboard by the authorized ATM manufacturer.

In step 10, the SKM receives an asymmetric key set from a trusted certificate authority (CA) with a private key PRSKM and a public key PU_{SKM}, for example an RSA key set. Either the key set can be used for all security keyboards or a unique key set can be generated for each security keyboard. The public key PU_{SKM} is loaded into the security module 2 of the security keyboard. The loading facility may be a personal computer with an application program, for example, to which the security module 2 is attached via a communication interface.

In step 20, the ATM manufacturer receives an asymmetric key set from the same CA with a private key PR_{ATM} and a public key PU_{ATM}, for example an RSA key set. The ATM manufacturer provides a certificate containing the public key PU_{ATM} to the SKM. This is preferably done via a secure data line, e.g., the Internet or an intranet. However the SKM may get access to the public key of the ATM manufacturer by any other suitable method. The SKM encrypts PU_{ATM} using its private key PR_{SKM}. The encrypted PU_{ATM} is later given to the ATM manufacturer, as described below.

In step 30, the SKM assembles components belonging to the country-independent part 30. The country-independent part in the preferred embodiment of the present invention includes a printed circuit board (PCB) 1 having a security module 2 containing all security-relevant functions (e.g., a security mechanism against manipulation and the user-authentication function) encapsulated with a security film that is connected to a built-in security switch (not shown), metal domes 5 for the key elements 3, a spacer layer 8, and a gasket 9. Furthermore, the PCB 1 has one or more security electrical contacts 6 with an assigned metal dome 7. When the country-independent parts are assembled and mounted with their country-specific parts by the assembler, the gasket 9 forces metal dome 7 to snap in and to short-circuit security contacts 6. This indicates to the built-in security mechanism against manipulation that the country-independent part is assembled correctly. Disassembling of the country-independent part automatically erases all security-relevant data in the security module 2. In another embodiment of the present invention the country-independent parts may be assembled and mounted by the SKM so that the gasket 9 forces the metal dome 7 to snap in and to short-circuit security contacts 6. When the country-independent part is completely assembled by the SKM in that embodiment all security-relevant functions except the user-authentication function are active.

The user-authentication function is only activated by the authorized ATM manufacturer when the final country-specific assembly process is completed and the authentication process has been performed successfully.

All security-relevant functions of the security keyboard are preferably stored within a customized EPROM or in a customized Flash EPROM which is part of the security module 2. At the latest when the country-independent part is completely assembled, the following information is loaded into the security module 2: the asymmetric keys PU_{SKM} and PU_{ATM}. Loading may be accomplished via a loading device, which may be a personal computer.

In step 40, the SKM provides completely assembled country-independent parts and different non-assembled country-specific layout parts to the ATM manufacturer, together with the PU_{ATM} encrypted by PR_{SKM}. In step 50, the ATM manufacturer assembles the country-independent parts with their appropriate country-specific parts to complete security keyboards. Then, in step 60, the ATM manufacturer loads the encrypted PU_{ATM} generated by using PRSKM into the security module 2 by means of a loading facility via a loading interface.

In step 70, a cryptographic algorithm stored in the security module 2 decrypts the encrypted PU_{ATM} by means of the PU_{SKM} stored in the security module 2. Then, a comparison component compares result of the decryption with the PU_{ATM} stored in the security module 2.

In step 80, if both PU_{ATM} values match and the built-in security against manipulation is active (the gasket 9 forces metal dome 7 to snap in and to short-circuit security contacts 6) the user-authentication in the security module 2 is automatically activated. Thereby the time, the date, and the ATM manufacturer identification number (ATM manufacturer ID) are automatically generated and stored in the security module 2.

In another embodiment of the present invention (not shown) the successful authentication does not automatically activate the user-authentication function but the following further steps are performed to activate the user-authentication: The ATM manufacturer sends a command to the security module 2 to activate the user-authentication for the security keyboard. The command may also include time, date and an ATM manufacturer identification number (ATM manufacturer ID) that is unique for the ATM manufacturer. The command may be encrypted using PR_{ATM}. In such case, the cryptographic algorithm decrypts the command using the valid PU_{ATM}. If the decrypted command is syntactically correct and allowed, the security keyboard executes the command and activates the user-authentication. The correctness of the command data can be ensured by methods like adding a hash value that is computed on the data and verifying the hash value when the command is decrypted. The command can also be sent to the security module 2 signed by the ATM manufacturer using its PR_{ATM}. The security module 2 will execute the command if the signature is verified successfully using the stored PU_{ATM}.

The assembled security keyboard can provide details of the assembly process, for example time, date, and the ATM ID which were initiated during the assembly process. The request can be sent in clear or encrypted under PR_{ATM}. If the request is encrypted the cryptographic algorithm can decrypt it using the PU_{ATM} stored in the secure module.

The data provided by the security module 2 can be sent in clear or encrypted under the requester's public key PU_{SKM} or PU_{ATM}. If the data is encrypted it is decrypted using the corresponding PR_{SKM} or PR_{ATM}.

FIG. 4 shows in more detail the components and data stored in the security module 2 of the country-independent part as provided to the assembler. The security module 2 that is part of the country-independent part preferably contains a cryptographic algorithm 150, a comparison component 130, a user-authentication component 110, and a communication interface 100 component for loading the components 150, 130, 110 into the security module 2. Furthermore, the keys PU_{ATM} (170) and PU_{SKM} (160) are preloaded by the SKM. Another embodiment may be that only PU_{SKM} is preloaded by the SKM and the assembler provides PU_{ATM} and the encrypted PU_{ATM} to the security module 2. The ATM manufacturer loads the PU_{ATM} and the encrypted PU_{ATM} generated by using PR_{SKM} into the security module 2 by means of a loading facility via a loading interface 100. The cryptographic algorithm 150 stored in the security module 2 decrypts the encrypted PU_{ATM} by means of the PU_{SKM} stored in the security module 2. Then, the comparison component 130 compares result of the decryption with the PU_{ATM} stored in the security module 2. When both PU_{ATM} values match and the built-in security function against manipulation is active, the user-authentication may be activated.

The present invention has been described exclusively in an ATM environment. However it is clear that the present invention may be used in any other device which requires the use of a security keyboard, e.g. all self-service terminals, ticket terminals etc.

What is claimed is:

1. A method for secure final assembly of a security keyboard by an assembler, the security keyboard comprising a country-independent part including a security module with a user-authentication function and a country-specific layout part, the method comprising the steps of:
receiving a country-independent part and a country-specific layout part from a provider, together with assigned data that is encrypted using a cryptographic algorithm;
assembling the country-independent part with the country-specific layout part to complete a security keyboard;
decrypting the assigned data using the cryptographic algorithm;
comparing the decrypted data with data stored in the security module; and
allowing activation of the user-authentication function in the security module only if the decrypted data matches the data stored in the security module.

2. A method according to claim 1, wherein the assembled country-independent part contains a security mechanism against mechanical manipulation.

3. A method according to claim 2, wherein the country-independent part is provided to the assembler in an already assembled state with activation of the security mechanism against mechanical manipulation.

4. A method according to claim 2, wherein the country-independent part is provided to the assembler in an already assembled state without activation of the security mechanism against mechanical manipulation.

5. A method according to claim 3, wherein the country-independent part comprises a printed circuit board with electrical contacts for keys of the country-specific layout part and a security mechanism against mechanical manipulation for erasure of all information and programs stored in the security module if the country-independent part is disassembled.

6. A method according to claim 2, wherein the step of allowing activation of the user-authentication function comprises the steps of:
sending a command to the security module to activate the user-authentication function if the decrypted data matches the data stored in the security module and the security mechanism against mechanical manipulation is activated, the command being encrypted by a private key of the assembler and including a time, a date, and an ID of the assembler;
decrypting the command in the security module using a corresponding public key of the assembler; and
automatically activating the user-authentication function storing the date, time, and assembler ID of the command in the security module.

7. A method according to claim 1, wherein the cryptographic algorithm is an asymmetric cryptographic algorithm.

8. A method according to claim 7, wherein the encrypted data is a public key of the assembler encrypted by a private key of the provider.

9. A method according to claim 8, wherein the security module of the country-independent part provided to the assembler contains the public key of the assembler and a public key corresponding to the private key of the provider, the encrypted data being loaded into the security module by the assembler when performing decryption.

10. A method according to claim 8, wherein the security module of the country-independent part provided to the assembler contains a public key corresponding to the private key of the provider, the public key of the assembler and the encrypted data being loaded into the security module by the assembler when performing decryption.

11. A method according to claim 8, wherein the public key of the assembler, a public key corresponding to the private key of the provider, and the encrypted data are loaded into the security module by the assembler when performing decryption.

12. A method according to claim 11, wherein the decryption is performed on the encrypted data when it is loaded into the security module by the assembler and the comparing step is successful if decrypted and plain data match.

13. A method according to claim 1, wherein the cryptographic algorithm is a symmetric cryptographic algorithm.

14. A method according to claim 1, wherein the cryptographic algorithm is stored in the security module.

15. A method according to claim 14, wherein the security module has an interface for providing the encrypted data to the cryptographic algorithm stored in the security module.

16. A method according to claim 1, wherein the cryptographic algorithm is stored outside the security module.

17. A method according to claim 1, wherein the security module of the country-independent part contains a comparison component for performing the comparing step.

18. A method according to claim 1, wherein the country-specific layout part includes language-specific keys.

19. A method according to claim 1, wherein the provider is a security keyboard manufacturer and the assembler is manufacturer of devices that require security keyboards.

20. A method according to claim 19, wherein the devices are automatic teller machines (ATMs).
